(19) United States
(12) Patent Application Publication
(10) Pub. No.: US 2025/0060973 A1
(43) Pub. Date: Feb. 20, 2025

(54) METHOD OF PROGRAM RUNNING, ELECTRONIC DEVICE AND STORAGE MEDIUM

(71) Applicant: Beijing Volcano Engine Technology Co., Ltd., Beijing (CN)

(72) Inventors: Zekun WANG, Beijing (CN); Di WU, Beijing (CN); Xuran YIN, Beijing (CN)

(21) Appl. No.: 18/789,058

(22) Filed: Jul. 30, 2024

(30) Foreign Application Priority Data
Aug. 18, 2023 (CN) 202311049105.1

(51) Int. Cl. G06F 9/445

(52) U.S. Cl. CPC G06F 9/44526

(57) ABSTRACT

A method of program running, an electronic device and a storage medium are provided. The method includes transmitting a first request to a host program through a plug-in module after receiving a call instruction for the plug-in module, the first request including an interface identifier used for indicating a target call interface, and the plug-in module being mounted in the host program and containing a network assembly program used for implementing a target function; in respond to the first request through the host program, calling the target call interface corresponding to the interface identifier, so as to obtain target data; and transmitting the target data to the plug-in module through the host program, and processing the target data through the plug-in module to execute the target function corresponding to the plug-in module.

### CROSS-REFERENCE TO RELATED APPLICATION

The present disclosure claims priority of the Chinese Patent Application No. 202311049105.1 filed on Aug. 18, 2023, the disclosure of which is incorporated herein by reference in its entirety as part of the present application.

### TECHNICAL FIELD

Embodiments of the present disclosure relate to a method of program running, an electronic device and a storage medium.

### BACKGROUND

Network assembly, which is called Web Assembly, i.e. WebAssembly (Wasm), is an emerging portable assembly language. Codes based on network assembly are executed in a sandbox at a speed close to native. It is often mounted as a functional module to a host program (Host) to implement specific functions, acting as a plug-in-like role.

When using the network assembly technology to develop an application program, a communication interface is usually defined in the code on the side of the host program in advance, and then when the compiled host program is run, the data exchange between the host program and the network assembly program is implemented through the communication interface.

### SUMMARY

An embodiment of the present disclosure provides a method of program running, an electronic device and a storage medium, aiming to overcome the problems of complex update process of an application program, high maintenance cost and the like.

Embodiments of the present disclosure provide a method of program running, including:
transmitting the first request to the host program through the plug-in module in response to receiving the call instruction for the plug-in module, the first request including the interface identifier used for indicating the target call interface, and the plug-in module being mounted in the host program and containing network assembly program used for implementing a target function; in respond to the first request through the host program, calling the target call interface corresponding to the interface identifier, so as to obtain target data; and transmitting the target data to the plug-in module through the host program, and processing the target data through the plug-in module to execute the target function corresponding to the plug-in module.

Embodiments of the present disclosure provide an apparatus of program running, including:
a first interaction unit, configured to transmit the first request to the host program through the plug-in module in response to receiving the call instruction for the plug-in module, the first request including the interface identifier used for indicating the target call interface, and the plug-in module being mounted in the host program and containing the network assembly program used for implementing the target function;
a call unit, configured to respond to the first request through the host program to call the target call interface corresponding to the interface identifier, so as to obtain the target data;
a second interaction unit, configured to transmit the target data to the plug-in module through the host program; and
a processing unit, configured to process the target data through the plug-in module to execute the target function corresponding to the plug-in module.

Embodiments of the present disclosure provide an electronic device including: at least one processor, and at least one memory;
the at least one memory stores computer executable instructions; and
the at least one processor executes the computer executable instruction stored in the at least one memory, so that the at least one processor executes the method of program running in the above and various possible designs in the above.

Embodiments of the present disclosure provide a non-transient computer-readable storage medium; computer-executable instructions are stored in the non-transient computer-readable storage medium; and when the processor executes the computer-executable instruction, the method of program running in the above and various possible designs in the above is implemented.

Embodiments of the present disclosure provide a computer program product, including a computer program; and the computer program implements the method of program running in the above and various possible designs in the above when executed by a processor.

### BRIEF DESCRIPTION OF DRAWINGS

In order to provide a clearer description of the technical solution in the embodiments of the present disclosure, the drawings that need to be used in the description of the embodiments will be briefly depicted below. Obviously, the drawings in the following description are some embodiments of the present disclosure. For those ordinary skilled in the art, other drawings may also be attained from these drawings without creative efforts.

FIG. 1 is an application scene diagram of a method of program running according to an embodiment of the present disclosure;

FIG. 2 is a flow schematic diagram 1 of a method of program running according to an embodiment of the present disclosure;

FIG. 3 is a flowchart of a specific implementation mode of a step S101 in an embodiment shown in FIG. 2;

FIG. 4 is a schematic diagram of a process of transmitting a first request according to an embodiment of the present disclosure;

FIG. 5 is a flow schematic diagram 2 of a method of program running according to an embodiment of the present disclosure;

FIG. 6 is a schematic diagram of a host interface module according to an embodiment of the present disclosure;

FIG. 7 is a schematic diagram of a target data request process according to an embodiment of the present disclosure;

FIG. 8 is a schematic diagram of a process of transmitting target data according to an embodiment of the present disclosure;

FIG. 9 is a structural block diagram of an apparatus of program running according to an embodiment of the present disclosure;

FIG. 10 is a structural schematic diagram of an electronic device according to an embodiment of the present disclosure; and

FIG. 11 is a hardware structural schematic diagram of an electronic device according to an embodiment of the present disclosure.

### DETAILED DESCRIPTION

In order to provide a clearer description of the technical solution in the embodiments of the present disclosure, the drawings that need to be used in the description of the embodiments will be briefly depicted below. Obviously, the drawings in the following description are some embodiments of the present disclosure. For those ordinary skilled in the art, other drawings may also be attained from these drawings without creative efforts.

It is to be noted that the user information (including but not limited to user device information, user personal information, etc.) and data (including but not limited to data used for analysis, stored data, displayed data, etc.) involved in the present disclosure are all information and data authorized by users or fully authorized by all parties. It is needed to collect, use, and process relevant data in accordance with the relevant laws, regulations and standards of the relevant countries and regions, and provide corresponding operation portals for the users to choose to authorize or refuse.

The following describes application scenes of embodiments of the present disclosure:

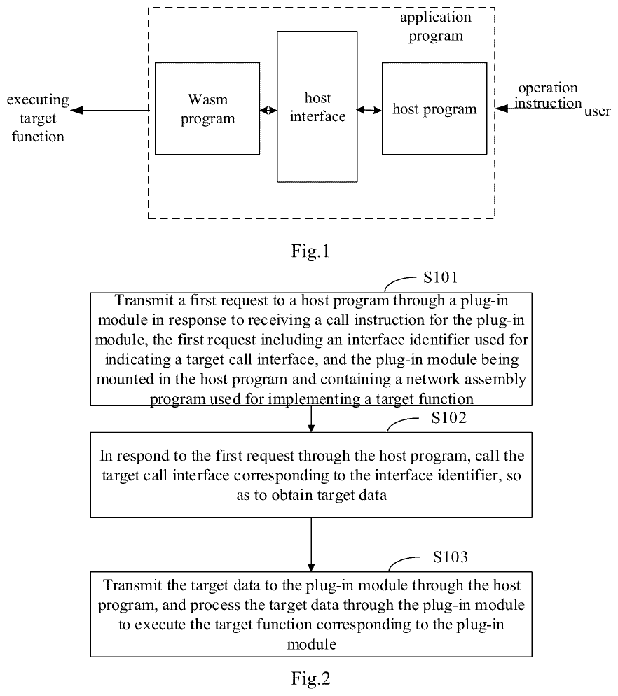

FIG. 1 is an application scene diagram of a method of program running according to an embodiment of the present disclosure. The method of program running according to the embodiment of the present disclosure can be applied to application scenes related to cloud computing such as Faas functions and plug-in platforms, and more specifically, it can be applied to the running process of an application program developed based on a network assembly technology (also referred as WebAssembly, abbreviated as Wasm). An executive object of this embodiment can be a terminal device for running the application program and can also be a server at a corresponding server side for running the application program, or other electronic devices with similar functions. As shown in FIG. 1, taking the terminal device as an example, the application program developed based on the network assembly technology includes a host program (Host) and a Wasm program, the host program is also a main program of the application program and is used for implementing main subject operation logic and functions of the application program, and the Wasm program is used for realizing a sub-function or processing step in the application program, such as data verification, data reading and data filtering. Data communication is carried out between the main program and the Wasm program through the host interface (Hostcall), thereby realizing request and data interaction between the main program and the Wasm program. When the user inputs an operation instruction to the application to trigger the target function in the application program, and if the target function is implemented by the Wasm program, an instruction request and data interaction will be performed between the Wasm program and the host program, and finally the execution of the target function in the application program is achieved.

In the application program developed based on the network assembly technology, due to some limitations of the network assembly technology in security, some functions of an operation system cannot be directly used, such as establishing a TCP link, and reading a file, or some methods for directly using the host program (Host) in the Wasm program. Under such condition, it is needed to set a host interface, and a plurality of Application Programming Interfaces (APIs) in the host interface are used for the Wasm program to call. The inventors of the present application found that, the host interface is generally fixedly set in the code on the side of the host program in advance; then the code on side of the host program is compiled to generate the host program; and because the communication interface is determined in the host program compiling process, there are problems such as that when the interface of one of the host program and a network assembly module is updated, and the implementation of the other one must be adjusted accordingly, resulting in the complex update process and high maintenance cost of the application program.

The embodiment of the present disclosure provides the method of program running to solve the above problems.

As shown in FIG. 2, FIG. 2 is a flow schematic diagram 1 of a program running method according to an embodiment of the present disclosure. The method according to this embodiment can be applied to the terminal device or a server. The method of program running includes:

Step S101: Transmit a first request to a host program through a plug-in module in response to receiving a call instruction for the plug-in module, the first request including an interface identifier used for indicating a target call interface, and the plug-in module being mounted in the host program and containing a network assembly program used for implementing a target function.

Step S102: Respond to the first request through the host program to call the target call interface corresponding to the interface identifier, so as to obtain target data.

Exemplarily, referring to the application scene schematic diagram shown in FIG. 1, by taking the terminal device as the executive object, a target application runs in the terminal device, and the target application includes the host program and the plug-in module mounted in the host program; the plug-in module includes the network assembly program, that is, the plug-in module is a functional module implemented based on the Wasm technology. The plug-in module can be arranged in the terminal device serving as the executive object in this embodiment and can also be arranged outside the terminal device and in other devices communicating with the terminal device, which is not specifically limited here.

Further, in the running process of the target application, when the target application needs to trigger the target function provided by the plug-in module, a call instruction for the plug-in module will be generated, and specifically, the call instruction can be generated based on the user operation and can also be generated based on the execution logic of the target application, which is not limited. After the plug-in module receives the call instruction, the plug-in module generates a corresponding first request based on the call instruction, and the first request is used for acquiring the target data from a side of the host program so as to execute the target function based on the target data. The first request includes an interface identifier used for indicating the target call interface, and the target call interface is an interface (API) arranged on a side of the host program.

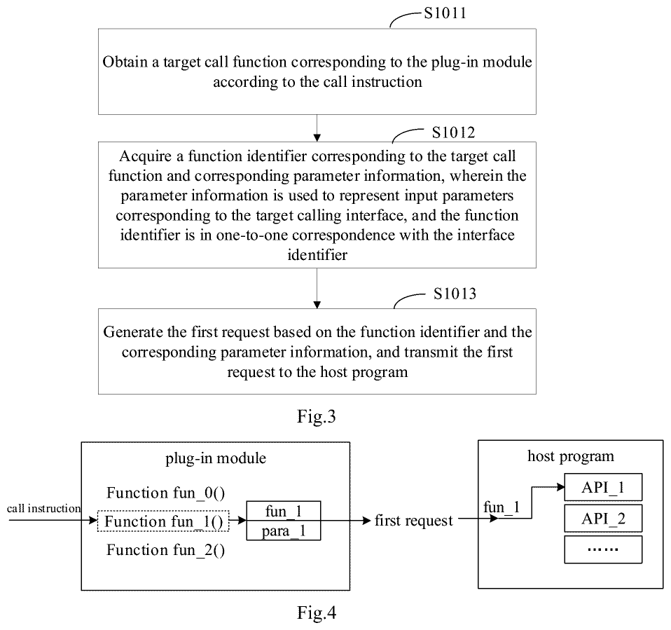

In a possible implementation mode, as shown in FIG. 3, the specific implementation mode of step S101 includes:

Step S1011: Obtain a target call function corresponding to the plug-in module according to the call instruction.

Step S1012: Acquire a function identifier corresponding to the target call function and corresponding parameter information, wherein the parameter information is used to represent input parameters corresponding to the target call interface, and the function identifier is in one-to-one correspondence with the interface identifier.

Step S1013: Generate the first request based on the function identifier and the corresponding parameter information and transmit the first request to the host program.

Exemplarily, after the call instruction is received, the plug-in module determines the corresponding call function that is the target call function according to the calling target indicated by the call instruction; for example, a target call function fun_1( ) is indicated by the call instruction, and fun_1( ) is the function identifier of the target call function; and the function identifier is in one-to-one correspondence with the interface identifier, that is, a corresponding interface (API) in the host program can be uniquely determined according to the function identifier fun_1. The parameter information of the target call function fun_1( ) refers to the input parameter corresponding to the target call interface, and the parameter information can be obtained by parsing the internal implementation of the target call function after the target call function fun_1( ) is determined. And then, based on the function identifier and the corresponding parameter information, the first request is generated and transmitted to the host program, and the host program can call the target call interface indicated by the function identifiers according to the function identifier in the first request and the corresponding parameter information.

FIG. 4 is a schematic diagram of a process of transmitting a first request according to an embodiment of the present disclosure. As shown in FIG. 4, the plug-in module includes a function fun_0( ) a function fun_1( ) and a function fun_2( ) and after receiving the call instruction, the plug-in module determines the function fun_1( ) as the target call function based on the call instruction; and then, a function identifier fun_1 corresponding to the target call function and a corresponding input parameter para_1 are acquired; exemplarily, the input parameter para_1 of the target call function fun_1( ) represents a file name, and the target call function fun_1(para_1) is used for obtaining a file named para_1. Then, the input parameter para_1 is serialized to generate the first request, and the first request is transmitted to the host program. On the other hand, the host program determines a target call interface API_1 corresponding to the function identifier fun_1 based on the function identifier fun_1 in the first request and the corresponding input parameter para_1, calls the target call interface API_1 by the input parameter para_1, and then obtains the target data after executing a method corresponding to the target call interface API_1.

Step S103: Transmit the target data to the plug-in module through the host program and process the target data through the plug-in module to execute the target function corresponding to the plug-in module.

Exemplarily, then after calling the target call interface to obtain the target data, the host program returns the target data to the plug-in module; the plug-in module utilizes the target data obtained from the host program to execute the corresponding target function, for example, the target function is to compress the file, because the plug-in module based on the Wasm technology cannot directly read the file to be zipped from the system, the plug-in module transmits the first request to the host program based on the above steps, so as to obtain the target data returned by the host program, and the target data is the file to be zipped, such as file data_0. Then, the plug-in module zips the file data_0 to be zipped to obtain a zipped file zip_data_0, so that the process of calling the target function in the target application is realized. In this process, the plug-in module and the host program are subjected to interface matching through the interface identifier in the first request, so that the interface calling process between the plug-in module and the host program is decoupled, the plug-in module and the host program can be independently updated and compiled, and mutual influence is avoided.

In this embodiment, the method includes: transmitting the first request to the host program through the plug-in module in response to receiving the call instruction for the plug-in module, the first request including the interface identifier used for indicating the target call interface, and the plug-in module being mounted in the host program and including the network assembly program used for implementing a target function; in respond to the first request through the host program, calling the target call interface corresponding to the interface identifier, so as to obtain the target data; and transmitting the target data to the plug-in module through the host program, and processing the target data through the plug-in module to execute the target function corresponding to the plug-in module. The interface identifier is set in the first request transmitted to the host program by the plug-in module implemented based on the network assembly program, thereby realizing the indication for the target call interface, thus the host program can dynamically select a matched target call interface for calling based on the first request, and the obtained target data is returned to the plug-in module to execute the corresponding target function; data interaction between the host program and the plug-in module is realized, and meanwhile, decoupling between the host program and the plug-in module is realized; and therefore, when updating the application, the host program or the plug-in module can be independently updated according to needs, so that the complexity of the updating process of the application is simplified, the updating efficiency is improved, and the maintenance cost of the application is reduced.

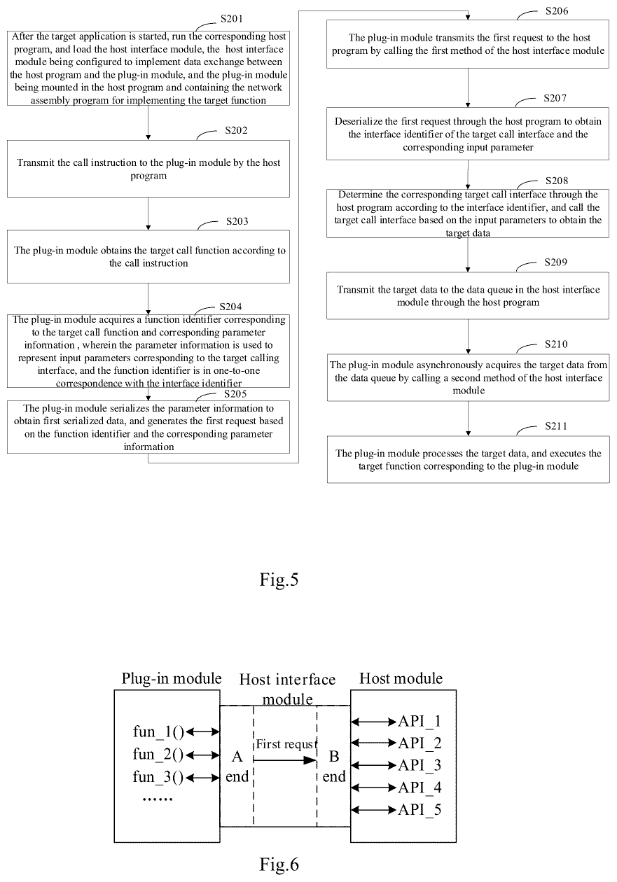

As shown in FIG. 5, FIG. 5 is a flow schematic diagram 2 of a method of program running according to an embodiment of the present disclosure. On the basis of the embodiment shown in FIG. 2, steps S101-S102 in this embodiment are further refined, and the method of program running includes:

Step S201: After the target application is started, run the corresponding host program, and load the host interface module, the host interface module being configured to implement data exchange between the host program and the plug-in module, and the plug-in module being mounted in the host program and containing the network assembly program for implementing the target function.

Exemplarily, after the target application is triggered to be started, the corresponding host program is run; and in the initialization stage of the host program, the host interface (HostCall) module for implementing data exchange between the host program and the plug-in module is loaded. The host interface module is a program function module, and after the host interface module is loaded in the initialization stage of the host program, a corresponding function interface can be provided for the plug-in module, so that the plug-in module can call the API in the host program by the function interface provided by the host interface module.

FIG. 6 is a schematic diagram of a host interface module according to an embodiment of the present disclosure; as shown in FIG. 6, one end (end A) of the host interface module corresponds to the plug-in module, and the other end (end B) corresponds to the host program, and the call functions (such as fun_1( ), fun_2( ) and fun_3 ( ) shown in the figure) in the plug-in module transmits a request (first request) to the host program by a function interface provided by the end A of the host interface module, and the request includes the interface identifier used for indicating the target call interface; and the host program obtains the request through the end B of the host interface module, and determines and calls a corresponding target call interface from a plurality of preset call interfaces (such as API_1, API_2, API_3, API_4, and API_5 shown in the figure) based on the interface identifier so as to realize the response to the request transmitted by the plug-in module.

Step S202: Transmit the call instruction to the plug-in module by the host program.

Step S203: the plug-in module obtains the target call function according to the call instruction.

Exemplarily, when the target application triggers the target function, for example, based on the user operation, the target application triggers the corresponding data processing function, the terminal device transmits the call instruction to the plug-in module through the host program corresponding to the target application, so as to call the plug-in module, and the plug-in module includes the network assembly program for implementing the target function, namely the Wasm program. After receiving the call instruction, the plug-in module responds to the call instruction to determine the target call function corresponding to the call instruction, namely the function for implementing the target function indicated by the call instruction, and the target call function acquires the corresponding target data from the side of the host program to support the implementation of the target function. The plug-in module receives the call instruction and determines a specific implementation process of the corresponding target call function based on the call instruction, detailed introduction is shown in the embodiment in FIG. 2 and will not be repeated here.

Step S204: The plug-in module acquires a function identifier corresponding to the target call function and corresponding parameter information, wherein the parameter information is used to represent input parameters corresponding to the target call interface, and the function identifier is in one-to-one correspondence with the interface identifier.

Step S205: The plug-in module serializes the parameter information to obtain first serialized data and generates the first request based on the function identifier and the corresponding parameter information.

Exemplarily, after determining the target call function, the plug-in module acquires the function identifier corresponding to the target call function and the corresponding parameter information. The function identifier is in one-to-one correspondence with the interface identifier, so after being responded by the host program, the host program can uniquely determine a call interface, namely the target call interface, based on the first request generated by the function identifier, thereby realizing one-to-one mapping from the functional interface required by the side of the plug-in module to the Application Programming Interface (API) on the host program. The specific implementation of obtaining the corresponding function identifier and the corresponding parameter information based on the target call function is introduced in detail in the embodiment shown in FIG. 2 and will not be repeated here.

Further, after the corresponding function identifier and the corresponding parameter information are obtained, serialization is carried out by taking the parameter information corresponding to the function identifier as a target, so as to obtain the first serialized data. The serialization refers to a process of converting original data into serialized data which has a specific format and meets a special effect rule. In this embodiment, the parameter information corresponding to the function identifier is taken as a target for serialization, aiming to generate specific data which can be identified and processed by the host interface module, namely the first serialized data, so as to improve the data transmission efficiency.

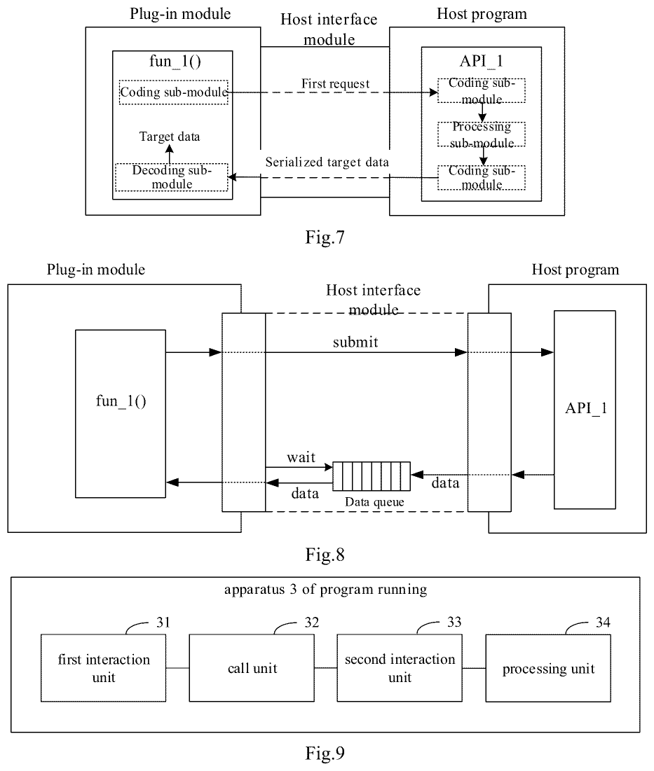

Correspondingly, on the side of the host program, in the process of performing data interaction through the host interface module, after the first serialized data transmitted by the host interface module is received, the first serialized data received from the host interface module is needed to be subjected to corresponding deserialization, so as to restore the parameter information corresponding to the function identifier, and then subsequent calling of the target call interface can be performed. FIG. 7 is a schematic diagram of a target data request process according to an embodiment of the present disclosure; as shown in FIG. 7, the target call function (shown as fun_1( ) in the figure) in the plug-in module includes a coding sub-module configured to serialize data and a decoding sub-module configured to deserialize the data; and in the process of transmitting the first request to the host program, the target call function codes the parameter information corresponding to the function identifier through the coding sub-module, then generates the first request including the function identifier and the parameter identifier, transmits the first request to the host interface module, and then forwards the first request to the host program through the interface host program. The coding sub-module and the decoding sub-module can be implemented based on serialization protocols such as Protobuf and flatbuffer, which is not repeated here.

Further, after receiving the first request, the host program determines the corresponding target call interface (API_1 shown in the figure) based on the function identifier; in a possible implementation, the first serialized data in the first request is inputted into the target call interface; the method corresponding to the target call interface is used for internally performing the processes of deserializing, processing and serializing on the first serialized data, that is, the first serialized data is sequentially processed by the decoding sub-module in the API_1, a processing sub-module and the coding sub-module to obtain the serialized data (namely, second serialized data) corresponding to the target data, and then the serialized target data is returned to an appearance module through the host interface module, and decoded by the decoding sub-module of the plug-in module, so as to restore the target data required for executing the target function.

Step S206: The plug-in module transmits the first request to the host program by calling the first method of the host interface module.

Exemplarily, the plug-in module transmits the first request to the host program by a specific first method provided by the host interface module, for example, a submit ( ) method, that is, the plug-in module can achieve the purpose of transmitting data to the host program by calling a submit (data) method, and the input parameter data in the submit ( ) method can be the first request, or output data generated after the plug-in module executes and completes the target function, for example, the target function is a function of zipping the data, and the output data is the zipped data. Through the submit ( ) method, the plug-in module can return the zipped data to the host program again, so that the function execution result for the target function in the target application is displayed.

Step S207: Deserialize the first request through the host program to obtain the interface identifier of the target call interface and the corresponding input parameter.

Step S208: Determine the corresponding target call interface through the host program according to the interface identifier and call the target call interface based on the input parameters to obtain the target data.

Exemplarily, after receiving the first request, firstly, the host program determines the corresponding interface identifier according to the function identifier in the first request, there is a one-to-one correspondence relationship between the function identifier and the interface identifier, a fixed mapping relationship is stored between the function identifier and the interface identifier, which is not specifically repeated and can be set as required. Then, the serialized parameter information is deserialized, thus the parameter information can be restored, and the input parameter corresponding to the parameter information can be obtained, namely the input parameter corresponding to the call interface. The specific implementation step of deserializing the parameter information is introduced in the part of introducing the serializing on the parameter information in step S205 and will not be repeated here.

Then, exemplarily, the host program selects the corresponding target call interface based on the interface identifier, calls the target call interface based on the input parameter in the first request, and executes the corresponding execution method to implement functions such as file reading and TCP connection establishment which cannot be independently completed by the plug-in module (Wasm program), so as to generate corresponding target data, and the target data can be specific data and files, such as output of a file reading method, and can also be a function execution result, such as output of a method for establishing TCP connection, which is not limited here.

Then, exemplarily, as shown in FIG. 7, after the target call interface is called, the obtained target data can be the serialized target data (namely second serialized data); and after the plug-in module receives the target data, deserialization needs to be carried out to obtain original and non-serialized target data; and in another possible implementation, the host program performs serialization processing on the target data to obtain the second serialized data matched with the host interface module. That is, after the target call interface is called, the obtained target data can be non-serialized data; then, the host program serializes the target data through other processing modules or steps (such as the coding sub-module) to obtain the serialized data (namely second serialized data), the serialized data is transmitted to the host interface module, and then transmitted to the plug-in module through the host interface module; and after receiving the target data, the plug-in module needs to deserialize the target data to obtain the original and non-serialized target data.

Step S209: Transmit the target data to the data queue in the host interface module through the host program.

Step S210: The plug-in module asynchronously acquires the target data from the data queue by calling a second method of the host interface module.

Exemplarily, after the host program generates the target data, the target data is transmitted to the host interface module, so that the purpose of transmitting the target data to the plug-in module is achieved. Specifically, the data queue is installed in the host interface module, and the host program sequentially transmits the target data to the data queue in the host interface module. On the other hand, the plug-in module calls the second method of the host interface module to continuously detect the data queue in the host interface module and polls the corresponding target data from the data queue in the host interface module when detecting that the data queue in the host interface module includes the data, thereby achieving the purpose of asynchronously acquiring the target data.

FIG. 8 is a schematic diagram of a process of transmitting target data according to an embodiment of the present disclosure; as shown in FIG. 8, the plug-in module calls the first method (shown as submit in the figure) of the host interface module to transmit the first request to the host program, and the host program determines a corresponding target call interface (shown as API_1 in the figure) based on the first request and calls the target call interface to obtain target data (shown as data in the figure). Then, the host program transmits the data to the data queue, and the data queue stores the data in a first-in first-out sequence. On the other hand, the plug-in module calls the second method (shown as wait in the figure) provided by the host interface module to detect the data queue; and when it is detected that the target data is stored in the data queue, the target data is sequentially polled from the data queue according to the storage sequence of the data in the data queue, so that the target data is transmitted into the plug-in module from the side of the host program through the host interface module. And then, the target call function (shown as fun_1( ) of the plug-in module can execute the corresponding target function based on the obtained target data.

Step S211: The plug-in module processes the target data and executes the target function corresponding to the plug-in module.

In this embodiment, the implementation of step S202 and step 209 are the same as those of the corresponding parts in step S101 and step S103 in the embodiment shown in FIG. 2, and the implementation can refer to the introduction of related content in the embodiment shown in FIG. 2 and is not repeated here one by one.

Corresponding to the method of program running of the above embodiment, FIG. 9 is a structural block diagram of an apparatus of program running according to an embodiment of the present disclosure. In order to facilitate explanation, only parts related to the embodiment of the present disclosure are shown. As shown in FIG. 9, the apparatus 3 of program running includes:

a first interaction unit 31, configured to transmit a first request to a host program through a plug-in module after receiving a call instruction for the plug-in module, the first request including an interface identifier used for indicating a target call interface, and the plug-in module being mounted in the host program and containing a network assembly program used for implementing a target function;
a call unit 32, configured to respond to the first request through the host program to call the target call interface corresponding to the interface identifier, so as to obtain target data; and a second interaction unit 33, configured to transmit the target data to the plug-in
module through the host program; and
a processing unit 34, configured to process the target data through the plug-in module to execute the target function corresponding to the plug-in module.

In one embodiment of the present disclosure, the first interaction unit 31 is further configured to: after the host program runs, load a host interface module, configured to implement data exchange between the host program and the plug-in module; and when transmitting the first request to the host program through the plug-in module, the first interaction unit 31 is specifically configured to transmit call a first method of the host interface module to transmit the first request to the host program by the plug-in module.

In one embodiment of the present disclosure, when transmitting the target data to the plug-in module through the host program, the second interaction unit 33 is specifically configured to: transmit the target data to a data queue in the host interface module through the host program; and plug-in module asynchronously acquire the target data from the data queue by calling a second method of the host interface module.

In one embodiment of the present disclosure, when transmitting the first request to the host program through the plug-in module, the first interaction unit 31 is specifically configured to: obtain a target call function corresponding to the plug-in module according to the call instruction; acquire a function identifier corresponding to the target call function and corresponding parameter information, wherein the parameter information is used to input parameters corresponding to the target call interface, and the function identifier is in one-to-one correspondence with the interface identifier; and generate the first request based on the function identifier and the corresponding parameter information, and transmit the first request to the host program.

In one embodiment of the present disclosure, after acquiring the function identifier corresponding to the target call function and corresponding parameter information, the first interaction unit 31 is further configured to: serialize the parameter information to obtain first serialized data; and when acquiring the function identifier corresponding to the target call function and the corresponding parameter information, the first interaction unit 31 is specifically configured to: generate the first request based on the function identifier and the first serialized data.

In one embodiment of the present disclosure, when in respond to the first request through the host program, calling the target call interface corresponding to the interface identifier, so as to obtain the target data, the call unit 32 is specifically configured to: deserialize the first request by the host program to obtain the interface identifier of the target call interface and the corresponding input parameter; determine the corresponding target call interface according to the interface identifier; and call the target call interface based on the input parameter to obtain the target data.

In one embodiment of the present disclosure, after obtaining the target data, the second interaction unit 33 is further configured to: serialize the target data by the host program to obtain second serialized data matched with the host interface module; and when transmitting the target data to the plug-in module through the host program, the second interaction unit 33 is specifically configured to transmit the second serialized data to the plug-in module through the host program.

Exemplarily, the first interaction unit 31, the call unit 32, the second interaction unit 33 and the processing unit 34 are connected in sequence. The apparatus 3 of program running according to this embodiment can execute the technical solution of the above embodiment of the method, the implementation principle and the technical effect are similar, and will not be repeated here.

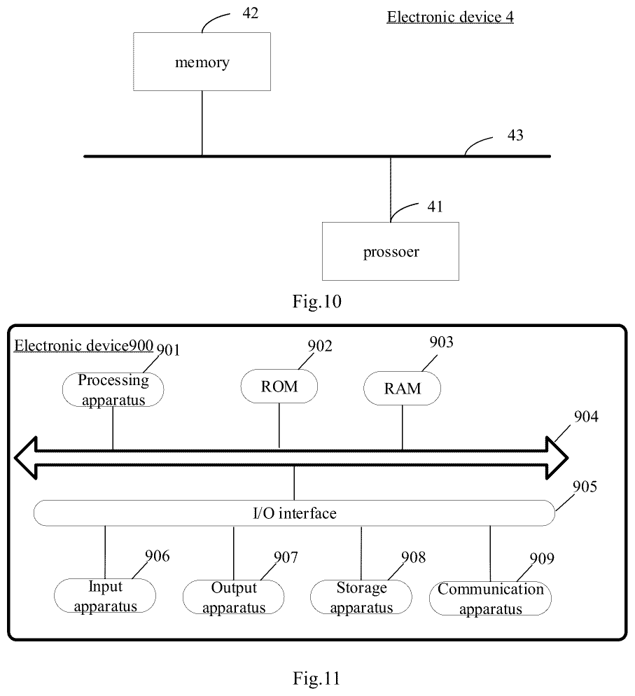

FIG. 10 is a structural schematic diagram of an electronic device according to an embodiment of the present disclosure, as shown in FIG. 10, the electronic device 4 includes:
at least one processor 41, and at least one memory 42 in communication connection with the at least one processor 41;
the at least one memory 42 stores computer executable instructions; and
the at least processor 41 executes the computer executable instructions stored in the at least one memory 42 to implement the method of program running in the embodiment as shown in FIGS. 2-7.

Optionally, the at least one processor 41 and the at least one memory 42 are connected through a bus 43.

Related descriptions can be understood corresponding to corresponding related descriptions and effects corresponding to steps in the embodiments in FIGS. 2-7 and will not be repeated here.

An embodiment of the present disclosure provides a non-transient computer readable storage medium. The computer executable instructions are stored in the non-transient computer readable storage medium, and the computer executable instructions are used for implementing the method of program running provided by any one of the embodiments corresponding to FIGS. 2-7 when executed by the processor.

In order to realize the above embodiment, an embodiment of the present disclosure further provides an electronic device.

With reference to FIG. 11, FIG. 11 illustrates a schematic structural diagram of an electronic device 900 suitable for implementing some embodiments of the present disclosure. The electronic device 900 may be a terminal device or serve. The terminal device may include but are not limited to mobile terminals such as a mobile phone, a notebook computer, a digital broadcasting receiver, a personal digital assistant (referred as PDA), a portable Android device (referred as PAD), a portable media player (referred as PMP), a vehicle-mounted terminal (e.g., a vehicle-mounted navigation terminal), or the like, and fixed terminals such as a digital TV, a desktop computer, or the like. The electronic device illustrated in FIG. 11 is merely an example and should not pose any limitation to the functions and the range of use of the embodiments of the present disclosure.

As illustrated in FIG. 11, the electronic device 900 may include a processing apparatus 901 (e.g., a central processing unit, a graphics processing unit, etc.), which can perform various suitable actions and processing according to a program stored in a read-only memory (referred as ROM) 902 or a program loaded from a storage apparatus 908 into a random-access memory (referred as RAM) 903. The RAM 903 further stores various programs and data required for operations of the electronic device 900. The processing apparatus 901, the ROM 902, and the RAM 903 are interconnected by means of a bus 904. An input/output (I/O) interface 905 is also connected to the bus 904.

Usually, the following apparatus may be connected to the I/O interface 905: an input apparatus 906 including, for example, a touch screen, a touch pad, a keyboard, a mouse, a camera, a microphone, an accelerometer, a gyroscope, or the like; an output apparatus 907 including, for example, a liquid crystal display (LCD), a loudspeaker, a vibrator, or the like; a storage apparatus 908 including, for example, a magnetic tape, a hard disk, or the like; and a communication apparatus 909. The communication apparatus 909 may allow the electronic device 900 to be in wireless or wired communication with other devices to exchange data. While FIG. 11 illustrates the electronic device 900 having various apparatuses, it should be understood that not all of the illustrated apparatuses are necessarily implemented or included. More or fewer apparatuses may be implemented or included alternatively.

Particularly, according to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in the flowcharts. In such embodiments, the computer program may be downloaded online through the communication apparatus 909 and installed, or may be installed from the storage apparatus 608, or may be installed from the ROM 902. When the computer program is executed by the processing apparatus 901, the above-mentioned functions defined in the methods of some embodiments of the present disclosure are performed.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus, or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate, or transmit a program used by or in combination with an instruction execution system, apparatus, or device. The program code contained on the computer-readable medium may be transmitted by using any suitable medium, including but not limited to an electric wire, a fiber-optic cable, radio frequency (RF) and the like, or any appropriate combination of them.

The above-mentioned computer-readable medium may be included in the above-mentioned electronic device or may also exist alone without being assembled into the electronic device.

The above-mentioned computer-readable medium carries one or more programs, and when the one or more programs are executed by the electronic device, the electronic device is caused to implement the methods of the above embodiments.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (referred as LAN) or a wide area network (referred as WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances. For example, the first acquisition unit also can be described a “unit for acquiring at least two internet protocol addresses.”

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus, or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

One or more embodiments of the present disclosure provide the method of program running, including:
transmitting the first request to the host program through the plug-in module after receiving the call instruction for the plug-in module, the first request including the interface identifier used for indicating the target call interface, and the plug-in module being mounted in the host program and containing network assembly program used for implementing a target function; in respond to the first request through the host program, calling the target call interface corresponding to the interface identifier, so as to obtain target data; and transmitting the target data to the plug-in module through the host program, and processing the target data through the plug-in module to execute the target function corresponding to the plug-in module.

According to one or more embodiments according to the present disclosure, the method further includes: after the host program runs, loading the host interface module which is configured to implement data exchange between the host program and the plug-in module; and the transmitting the first request to a host program through the plug-in module includes: the plug-in module transmitting the first request to the host program by calling the first method of the host interface module.

According to one or more embodiments of the present disclosure, the transmitting the target data to the plug-in module through the host program includes: transmitting the target data to the data queue in the host interface module through the host program; and the plug-in module asynchronously acquiring the target data from the data queue by calling the second method of the host interface module.

According to one or more embodiments of the present disclosure, the transmitting the first request to the host program through the plug-in module includes: obtaining the target call function corresponding to the plug-in module according to the call instruction; acquiring the function identifier corresponding to the target call function and the corresponding parameter information, wherein the parameter information is used to represent the input parameters corresponding to the target call interface, and the function identifier is in one-to-one correspondence with the interface identifier; and generating the first request based on the function identifier and the corresponding parameter information, and transmitting the first request to the host program.

According to one or more embodiments of the present disclosure, after acquiring the function identifier corresponding to the target call function and corresponding parameter information, the method further includes: serializing the parameter information to obtain the first serialized data; and the generating the first request based on the function identifiers and the corresponding parameter information includes: generating the first request based on the function identifier and the first serialized data.

According to one or more embodiments of the present disclosure, in respond to the first request through the host program, calling the target call interface corresponding to the interface identifier, so as to obtain the target data includes: deserializing the first request by the host program to obtain the interface identifier of the target call interface and the corresponding input parameter; determining the corresponding target call interface according to the interface identifier; and calling the target call interface based on the input parameter to obtain the target data.

According to one or more embodiments of the present disclosure, after obtaining the target data, the method further includes: serializing the target data by the host program to obtain the second serialized data matched with the host interface module; and the transmitting the target data to the plug-in module through the host program includes: transmitting the second serialized data to the plug-in module through the host program.

One or more embodiments of the present disclosure provide the apparatus of program running, including:
the first interaction unit, configured to transmit the first request to the host program through the plug-in module in response to receiving the call instruction for the plug-in module, the first request including the interface identifier used for indicating the target call interface, and the plug-in module being mounted in the host program and containing the network assembly program used for implementing the target function;
the call unit, configured to respond to the first request through the host program to call the target call interface corresponding to the interface identifier, so as to obtain the target data;
the second interaction unit, configured to transmit the target data to the plug-in module through the host program; and
the processing unit, configured to process the target data through the plug-in module to execute the target function corresponding to the plug-in module.

According to one or more embodiments of the present disclosure, the first interaction unit is further configured to: after the host program runs, load the host interface module which is configured to implement data exchange between the host program and the plug-in module; and when transmitting the first request to the host program through the plug-in module, the first interaction unit is specifically configured to: the plug-in module transmit the first request to the host program by calling the first method of the host interface module.

According to one or more embodiments of the present disclosure, when transmitting the target data to the plug-in module through the host program, the second interaction unit is specifically configured to: transmit the target data to the data queue in the host interface module through the host program; and the plug-in module asynchronously acquire the target data from the data queue by calling the second method of the host interface module.

According to one or more embodiments of the present disclosure, when transmitting the first request to the host program through the plug-in module, the first interaction unit is specifically configured to: obtain the target call function corresponding to the plug-in module according to the call instruction; acquire the function identifier corresponding to the target call function and the corresponding parameter information, wherein the parameter information is used to represent input parameters corresponding to the target call interface, and the function identifier is in one-to-one correspondence with the interface identifier; and generate the first request based on the function identifier and the corresponding parameter information, and transmit the first request to the host program.

According to one or more embodiments of the present disclosure, after acquiring the function identifier corresponding to the target call function and the corresponding parameter information, the first interaction unit is further configured to: serialize the parameter information to obtain the first serialized data; and when generating the first request based on the function identifier and the corresponding parameter information, the first interaction unit is specifically configured to: generate the first request based on the function identifier and the first serialized data.

According to one or more embodiments of the present disclosure, when in respond to the first request through the host program to call the target, call interface corresponding to the interface identifier, so as to obtain the target data, the call unit is specifically configured to: deserialize the first request by the host program to obtain the interface identifier of the target call interface and the corresponding input parameter; determine the corresponding target call interface according to the interface identifier; and call the target call interface based on the input parameters to obtain the target data.

According to one or more embodiments of the present disclosure, after obtaining the target data, the second interaction unit is further configured to: serialize the target data by the host program to obtain the second serialized data matched with the host interface module; and when transmitting the target data to the plug-in module through the host program, the second interaction unit is specifically configured to: transmit the second serialized data to the plug-in module through the host program.

One or more embodiments of the present disclosure provide an electronic device, including: at least one processor, and at least one memory;
the at least one memory stores computer executable instructions; and
the at least one processor executes the computer executable instruction stored in the at least one memory, so that the at least one processor executes the method of program running in the above and various possible designs in the above.

One or more embodiments of the present disclosure provide a non-transient computer-readable storage medium; computer-executable instructions are stored in the non-transient computer-readable storage medium; and when the processor executes the computer-executable instruction, the method of program running in the above and various possible designs in the above is implemented.

One or more embodiments of the present disclosure provide a computer program product, including a computer program; and the computer program implements the method of program running in the above and various possible designs in the above when executed by a processor.

The foregoing are merely descriptions of the preferred embodiments of the present disclosure and the explanations of the technical principles involved. It will be appreciated by those skilled in the art that the scope of the disclosure involved herein is not limited to the technical solutions formed by a specific combination of the technical features described above and shall cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

In addition, while operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the present disclosure. Some features described in the context of a separate embodiment may also be combined in a single embodiment. Rather, various features described in the context of a single embodiment may also be implemented separately or in any appropriate sub-combination in a plurality of embodiments.

Although the present subject matter has been described in a language specific to structural features and/or logical method acts, it will be appreciated that the subject matter defined in the appended claims is not necessarily limited to the particular features and acts described above. Rather, the particular features and acts described above are merely exemplary forms for implementing the claims.

1. A method of program running, comprising:
transmitting a first request to a host program through a plug-in module in response to receiving a call instruction for the plug-in module, the first request comprising an interface identifier used for indicating a target call interface, and the plug-in module being mounted in the host program and containing a network assembly program used for implementing a target function;
in respond to the first request through the host program, calling the target call interface corresponding to the interface identifier, so as to obtain target data; and
transmitting the target data to the plug-in module through the host program and processing the target data through the plug-in module to execute the target function corresponding to the plug-in module.

2. The method according to claim 1, further comprising:
loading a host interface module after the host program runs, the host interface module being configured to implement data exchange between the host program and the plug-in module, wherein
the transmitting a first request to a host program through a plug-in module comprises:
the plug-in module transmitting the first request to the host program by calling a first method of the host interface module.

3. The method according to claim 2, wherein the transmitting the target data to the plug-in module through the host program comprises:
transmitting the target data to a data queue in the host interface module through the host program; and
the plug-in module asynchronously acquiring the target data from the data queue by calling a second method of the host interface module.

4. The method according to claim 1, wherein the transmitting a first request to a host program through a plug-in module comprises:
obtaining a target call function corresponding to the plug-in module according to the call instruction;
acquiring a function identifier corresponding to the target call function and corresponding parameter information, wherein the parameter information is used to represent input parameters corresponding to the target call interface, and the function identifier is in one-to-one correspondence with the interface identifier; and
generating the first request based on the function identifier and the corresponding parameter information and transmitting the first request to the host program.

5. The method according to claim 4, wherein after acquiring the function identifier corresponding to the target call function and the corresponding parameter information, the method further comprises:
serializing the parameter information to obtain first serialized data; and
the generating the first request based on the function identifier and the corresponding parameter information comprises:
generating the first request based on the function identifier and the first serialized data.

6. The method according to claim 1, wherein in respond to the first request through the host program, calling the target call interface corresponding to the interface identifier, so as to obtain target data comprises:
deserializing the first request by the host program to obtain the interface identifier of the target call interface and the corresponding input parameter;
determining the corresponding target call interface according to the interface identifier; and
calling the target call interface based on the input parameter to obtain the target data.

7. The method according to claim 6, wherein after obtaining the target data, the method further comprises:
serializing the target data by the host program to obtain second serialized data matched with the host interface module; and
the transmitting the target data to the plug-in module through the host program comprises:
transmitting the second serialized data to the plug-in module through the host program.

8. An electronic device, comprising: at least one processor and at least one memory;
the at least one memory stores computer executable instructions; and
the at least one processor executes the computer executable instructions stored in the at least one memory, so that the processor executes a method of program running comprising:
transmitting a first request to a host program through a plug-in module in response to receiving a call instruction for the plug-in module, the first request comprising an interface identifier used for indicating a target call interface, and the plug-in module being mounted in the host program and containing a network assembly program used for implementing a target function;
in respond to the first request through the host program, calling the target call interface corresponding to the interface identifier, so as to obtain target data; and
transmitting the target data to the plug-in module through the host program and processing the target data through the plug-in module to execute the target function corresponding to the plug-in module.

9. The electronic device according to claim 8, wherein the method further comprises:
loading a host interface module, after the host program runs, the host interface module being configured to implement data exchange between the host program and the plug-in module, wherein
the transmitting a first request to a host program through a plug-in module comprises:
the plug-in module transmitting the first request to the host program by calling a first method of the host interface module.

10. The electronic device according to claim 9, wherein the transmitting the target data to the plug-in module through the host program comprises:
transmitting the target data to a data queue in the host interface module through the host program; and
the plug-in module asynchronously acquiring the target data from the data queue by calling a second method of the host interface module.

11. The electronic device according to claim 8, wherein the transmitting a first request to a host program through a plug-in module comprises:
obtaining a target call function corresponding to the plug-in module according to the call instruction;
acquiring a function identifier corresponding to the target call function and corresponding parameter information, wherein the parameter information is used to represent input parameters corresponding to the target call interface, and the function identifier in in one-to-one correspondence with the interface identifier; and
generating the first request based on the function identifier and the corresponding parameter information and transmitting the first request to the host program.

12. The electronic device according to claim 11, wherein after acquiring the function identifier corresponding to the target call function and the corresponding parameter information, the method further comprises:
serializing the parameter information to obtain first serialized data; and
the generating the first request based on the function identifier and the corresponding parameter information comprises:
generating the first request based on the function identifier and the first serialized data.

13. The electronic device according to claim 8, wherein in respond to the first request through the host program, calling the target call interface corresponding to the interface identifier, so as to obtain target data comprises:
deserializing the first request by the host program to obtain the interface identifier of the target call interface and the corresponding input parameter;
determining the corresponding target call interface according to the interface identifier; and
calling the target call interface based on the input parameter to obtain the target data.

14. The electronic device according to claim 13, wherein after obtaining the target data, the method further comprises:
serializing the target data by the host program to obtain second serialized data matched with the host interface module; and
the transmitting the target data to the plug-in module through the host program comprises:
transmitting the second serialized data to the plug-in module through the host program.

15. A non-transient computer-readable storage medium, wherein computer-executable instructions are stored in the non-transient computer-readable storage medium, and when a processor executes the computer-executable instruction, a method of program running is implemented and the method comprises:
transmitting a first request to a host program through a plug-in module in response to receiving a call instruction for the plug-in module, the first request comprising an interface identifier used for indicating a target call interface, and the plug-in module being mounted in the host program and containing a network assembly program used for implementing a target function;
in respond to the first request through the host program, calling the target call interface corresponding to the interface identifier, so as to obtain target data; and
transmitting the target data to the plug-in module through the host program and processing the target data through the plug-in module to execute the target function corresponding to the plug-in module.

16. The non-transient computer-readable storage medium according to claim 15, wherein the method further comprises:
loading a host interface module after the host program runs, the host interface module being configured to implement data exchange between the host program and the plug-in module, wherein
the transmitting a first request to a host program through a plug-in module comprises:
the plug-in module transmitting the first request to the host program by calling a first method of the host interface module.

17. The non-transient computer-readable storage medium according to claim 16, wherein the transmitting the target data to the plug-in module through the host program comprises:
transmitting the target data to a data queue in the host interface module through the host program; and
the plug-in module asynchronously acquiring the target data from the data queue by calling a second method of the host interface module.

18. The non-transient computer-readable storage medium according to claim 15, wherein the transmitting a first request to a host program through a plug-in module comprises:
obtaining a target call function corresponding to the plug-in module according to the call instruction;
acquiring a function identifier corresponding to the target call function and corresponding parameter information, wherein the parameter information is used to represent input parameters corresponding to the target call interface, and the function identifier is in one-to-one correspondence with the interface identifier; and
generating the first request based on the function identifier and the corresponding parameter information and transmitting the first request to the host program.

19. The non-transient computer-readable storage medium according to claim 18, wherein after acquiring the function identifier corresponding to the target call function and the corresponding parameter information, the method further comprises:
serializing the parameter information to obtain first serialized data; and
the generating the first request based on the function identifier and the corresponding parameter information comprises:
generating the first request based on the function identifier and the first serialized data.

20. The non-transient computer-readable storage medium according to claim 15, wherein in respond to the first request through the host program, calling the target call interface corresponding to the interface identifier, so as to obtain target data comprises:
deserializing the first request by the host program to obtain the interface identifier of the target call interface and the corresponding input parameter;
determining the corresponding target call interface according to the interface identifier; and
calling the target call interface based on the input parameter to obtain the target data.
